(19) United States
(12) Patent Application Publication
(10) Pub. No.: US 2026/0086878 A1
(43) Pub. Date: Mar. 26, 2026

(54) MAXIMIZING RESOURCE USAGE FOR DATABASE VIRTUALIZATION CLOUD PROVISIONING

(71) Applicant: Oracle International Corporation, Redwood Shores, CA (US)

(72) Inventors: Deepesh Lall, Kanpur (IN); Shashidhara Tadaga, Bengaluru (IN); Nagarajan Muthukrishnan, San Ramon, CA (US)

(73) Assignee: Oracle International Corporation, Redwood Shores, CA (US)

(21) Appl. No.: 18/898,529

(22) Filed: Sep. 26, 2024

(51) Int. Cl. G06F 9/50; G06F 9/455

(52) U.S. Cl. CPC G06F 9/5077; G06F 9/45558; G06F 9/5072; G06F 2009/4557; G06F 2009/45587; G06F 2209/501

(57) ABSTRACT

Described are improved systems, computer program products, and methods for providing an improved approach to implement database VM placement. An approach is provided to implement an efficient distribution of VMs to maintain high availability and performance alongside efficiently reserving and utilizing the common backend resources.

### BACKGROUND

In a cloud computing environment, computing systems may be provided as a service to customers. One of the main reasons for the rising popularity of cloud computing is that the cloud computing model typically allows customers to avoid or minimize both the upfront costs and ongoing costs that are associated with maintenance of IT infrastructures. Moreover, the cloud computing paradigm permits high levels of flexibility for the customer with regards to its usage and consumption requirements for computing resources, since the customer only pays for the resources that it actually needs rather than investing in a massive data center infrastructure that may or may not be efficiently utilized at any given period of time.

The cloud resources may be used for any type of purpose or applicable usage configuration by a customer. For example, the cloud provider might host a large number of virtualized processing entities (such as “virtual machines” or “VMs”) on behalf of the customer in the cloud infrastructure. The cloud provider may provide devices from within its own infrastructure location that are utilized by the cloud customers. In addition, the cloud provider may provide various services (e.g., database services) to customers from the cloud. As yet another example, the cloud provider may provide the underlying hardware device to the customer (e.g., where the device is located within the customer's own data center), but handle implementation and administration of the device as part of the cloud provider's cloud environment.

In a multi-tenant system, the customer may have their database VMs assigned to a computing node that is shared with other tenants. When a customer seeks to have a database VM provisioned, there is typically a limited choice of nodes at which to provision the VM. The problem is that issues may arise if the database VM is not assigned to an optimally correct node. For example, if the VM is assigned to a node in a manner where resources are inefficiently allocated across the multiple nodes, then both the overall performance of the system as well as that of the individual VM could suffer.

Therefore, there is a need for an improved approach to perform database VM provisioning that addresses the issues identified above.

### SUMMARY

Some embodiments of the invention provide an improved approach to implement database VM placement. Some embodiments support an enterprise-level database application for multiple tenants, where an efficient distribution of VMs is performed to maintain high availability and performance alongside efficiently reserving and utilizing the common backend resources.

Further details of aspects, objects and advantages of the disclosure are described below in the detailed description, drawings and claims. Both the foregoing general description and the following detailed description are exemplary and explanatory, and are not intended to be limiting as to the scope of the disclosure.

### BRIEF DESCRIPTION OF FIGURES

The drawings illustrate the design and utility of some embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the disclosure, a more detailed description of the present disclosure briefly described above will be rendered by reference to specific embodiments thereof, which are illustrated in the accompanying drawings. Understanding that these drawings depict only typical embodiments of the disclosure and are not therefore to be considered limiting of its scope.

The drawings use like reference numerals to identify like elements. A letter after a reference numeral, such as “120a,” indicates that the text refers specifically to the element having that particular reference numeral. A reference numeral in the text without a following letter, such as “120,” refers to any or all of the elements in the drawings bearing that reference numeral (e.g., “120” in the text refers to reference numerals “120a” and/or “120b” in the drawings). The disclosure will be described and explained with additional specificity and detail through the use of the accompanying drawings in which:

FIG. 1 shows an example cloud computing environment in which some embodiments of the invention may be implemented.

FIG. 2 shows a high flowchart of an approach to implement some embodiments of the invention.

FIGS. 3 and 4 provide an illustration of an example environment in which some embodiments of the invention may be applied.

FIG. 5 shows a detailed flowchart of an approach to implement some embodiments of the invention.

FIG. 6 shows a plot of the VM-optimum-density-deviation metrics equation.

FIGS. 7-10 provide several examples of the determination of VM optimum density deviation.

FIG. 11 illustrates a block diagram of an illustrative computing system suitable for implementing an embodiment of the present disclosure.

FIG. 12 illustrates a block diagram of one or more components of a system environment by which more efficient access to ordered sequences in a database environment is provided, in accordance with an embodiment of the present disclosure.

### DETAILED DESCRIPTION

Various embodiments will now be described in detail, which are provided as illustrative examples of the disclosure so as to enable those skilled in the art to practice the disclosure. Notably, the figures and the examples below are not meant to limit the scope of the present disclosure. Where certain elements of the present disclosure may be partially or fully implemented using known components (or methods or processes), only those portions of such known components (or methods or processes) that are necessary for an understanding of the present disclosure will be described, and the detailed descriptions of other portions of such known components (or methods or processes) will be omitted so as not to obscure the disclosure. Further, various embodiments encompass present and future known equivalents to the components referred to herein by way of illustration.

Some of the terms used in this description are defined below for easy reference. The presented terms and their respective definitions are not rigidly restricted to these definitions—a term may be further defined by the term's use within this disclosure. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

In an autonomous database cloud environment, the placement of VM clusters has become a significant issue for a multi-tenant cloud provider. This is because it is important to correctly identify a placement for a database VM in order to maintain customer satisfaction for the availability and high performance of the customer's workload, along with optimum resource utilization of highly sophisticated and efficient shared hardware. This is especially a thorny problem when there is a need to place the cluster resources on an on-the-fly basis. Indeed, this problem belongs to a class of computationally complex problems (NP-complete), where generally the cloud providers aim to distribute the VMs in separate compute nodes for maintaining the availability of the customer and prevent downtime for the provider service.

Some embodiments of the invention provide an improved approach to implement database VM placement.

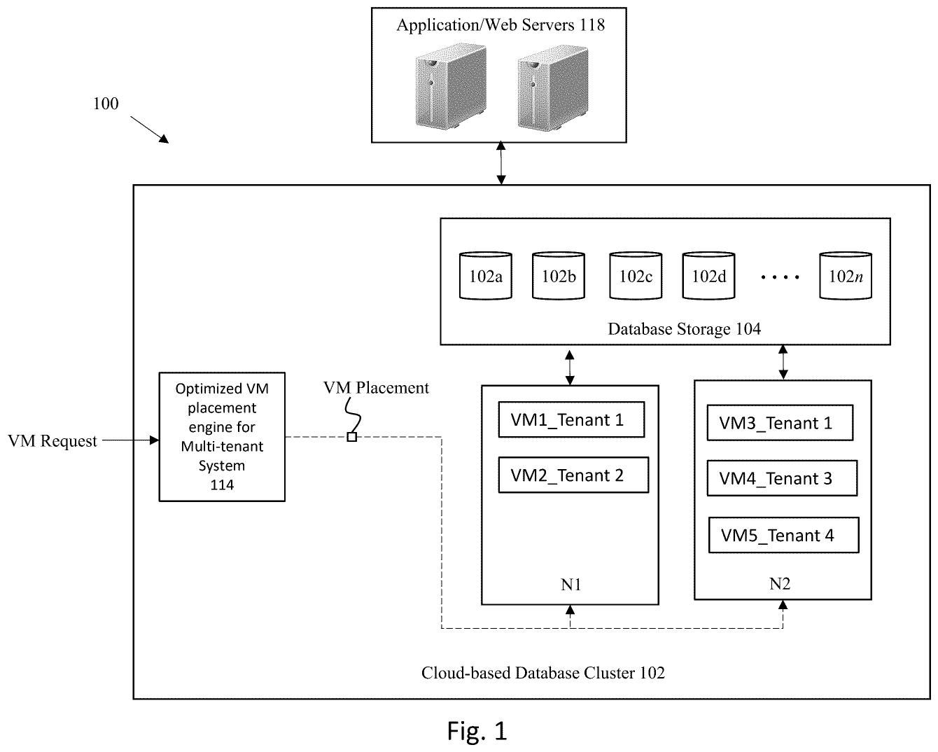

FIG. 1 shows an example cloud computing environment 100 in which some embodiments of the invention may be implemented. Here, the example cloud computing environment 100 corresponds to an environment in the cloud where computing systems may be provided as a service to customers.

In the figure, the cloud resources provided to a user is used to implement a cloud-based database service embodying one or more virtual database clusters. A database cluster is a type of system that allows the underlying servers within the computing infrastructure to communicate with each other so that they appear to function as a collective unit. Although the servers may be configured as standalone servers, each server has additional processes that communicate with other servers and where the different servers may access a shared/common set of database storage objects. The clustered database system therefore contains a shared architecture in which multiple running instances can each be used to manage a set of shared physical data files.

The clustered database environment 102 includes a shared database and allows a single database to be run across multiple instances/nodes (e.g., servers) in order to improve or maximize availability and to enable horizontal scalability, while accessing shared storage (e.g., the shared storage 104). For example, the clustered database environment may include a plurality of instances, where each instance of the plurality of instances may correspond to one or more virtualized entities (such as a VM) that perform database-related operations in the system. Each of the database instances may reside on a separate host, but in which the cluster infrastructure allows access to a single shared database via multiple database instances. In this way, the separate instances appear as if they are one system to applications/web servers (118) and end users.

The database system may include one or more users or database applications within the system that operate from or using a user station to issue commands to be processed by database management system (DBMS) upon one or more database tables. The user stations and/or the servers that host or operate with the database system comprises any type of computing device that may be used to implement, operate, or interface with the database. Examples of such devices include, for example, workstations, personal computers, mobile devices, servers, hosts, nodes, or remote computing terminals. The user station comprises a display device, such as a display monitor, for displaying a user interface to users at the user station. The user station also comprises one or more input devices for the user to provide operational control over the activities of the system, such as a mouse or keyboard to manipulate a pointing object in a graphical user interface to generate user inputs. The database system may be communicatively coupled to a storage device (e.g., a storage subsystem or appliance) over a network. The storage device comprises any storage mechanism that may be employed by the database system to hold storage content, such as but not limited to a hard disk drive, SSD, persistent memory, storage array, network attached storage, etc.

The database storage 104 may include any number of data storage devices and/or objects 102a-n that are stored within the system, and which consume storage space on the database storage 104. In a shared-everything database cluster, all nodes/instances in the cluster may modify the data segments stored on the shared storage system.

In general, database applications and/or end users interact with a database system by submitting commands that cause the database to perform operations on data stored in a database. For the database server to process the commands, the commands typically conform to a database language supported by the database server. An example of a commonly used database language supported by many database servers is known as the Structured Query Language (SQL). A database “transaction” corresponds to a unit of activity performed at the database that may include any number of different statements or commands for execution. ACID (Atomicity, Consistency, Isolation, Durability) is a set of properties that guarantees that database transactions are processed reliably. Atomicity requires that each transaction is all or nothing; if any part of the transaction fails, then the database state should not be changed by the transaction. Consistency requires that a database remains in a consistent state before and after a transaction. Isolation requires that other operations cannot see the database in an intermediate state caused by the processing of a current transaction that has not yet committed. Durability requires that, once a transaction is committed, the transaction will persist.

In a cloud environment of FIG. 1, a multi-tenant environment is provided where cloud resources may be allocated simultaneously to multiple different tenants. For example, the cloud provider might host a large number of virtualized processing entities (e.g., VMs) on behalf of multiple customers in the cloud infrastructure, such as compute nodes N1 and N2. In this figure, node N1 is shown as having VMs from multiple tenants, including VM1 from Tenant 1 and VM2 from Tenant 2. Node N2 is shown as having VM3 from Tenant 1, VM 4 from Tenatn 3, and VM5 from Tenant 4.

The issue addressed by this disclosure is that when a request is received to place a new VM onto one of the multi-tenant nodes, there should be a placement process that optimizes the placement of that VM. To support an enterprise-level database application for multiple tenants, it is very important to provide an efficient distribution of VMs to maintain the high availability and performance alongside efficiently reserving and utilizing the common backend resources.

Embodiments of the invention provide an optimized placement engine 114 to efficiently identify the correct node to allocate a VM. The engine 114 uses a methodology to measure consolidation with respect to optimal packing of the VMs requested on individual compute nodes with the metric, and to further use it to reduce resource wastage across the infrastructure by minimizing the factors contributing to such wastage.

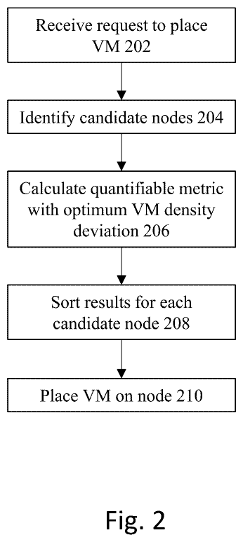

FIG. 2 shows a high flowchart of an approach to implement some embodiments of the invention. At 202, a request is received to place a database VM. Any suitable reason may exist to desire placement of a VM. For example, the request may be to provision a new VM, to migrate an existing VM from its current location to a new location, or to change the location of a VM for maintenance purposes. At 204, a set of candidate nodes is identified for the VM placement request.

At 206, a calculation is performed to identify, for each candidate node, an objective measure of the appropriateness of that node for placement of the VM. The goal is to maximize the optimal placement of the VM to an identifiable node. It is noted that the calculations should consider that the number of VMs in a compute node can be generally limited by a configurable VM-Max measure (a maximum measure of the number of VMs on a node). This consideration should understand the resource limits, if any, in hypervisor for the system. It is noted that too many VMs can bring down the efficiency of a node, since fixed cost may be associated with the VMs and a reduced number of DB resources. Therefore, the current approach will make placement decision while taking into account the VM-Max measure, since placing too many small VMs on a node can hit that VM-Max, lead to resource wastage. As such, at 206, the placement calculation will calculate VM placement and resource efficiency based on a VM-Max measure.

It is noted that, for instance in certain circumstances, placing a single VM to occupy one compute node may provide the best possible placement, whereas placing a VM-max number of minimum-resource VMs in one compute node may correspond to a worst possible placement. With some embodiments of the present invention, the choice is made through calculating VM optimum density deviation values. Further details for these calculations in some embodiments are provided below.

At 208, a sorting is performed for the results that were calculated for each of the candidate nodes. Thereafter, the best candidate node is selected for placement. At 210, the VM is placed on the selected candidate node.

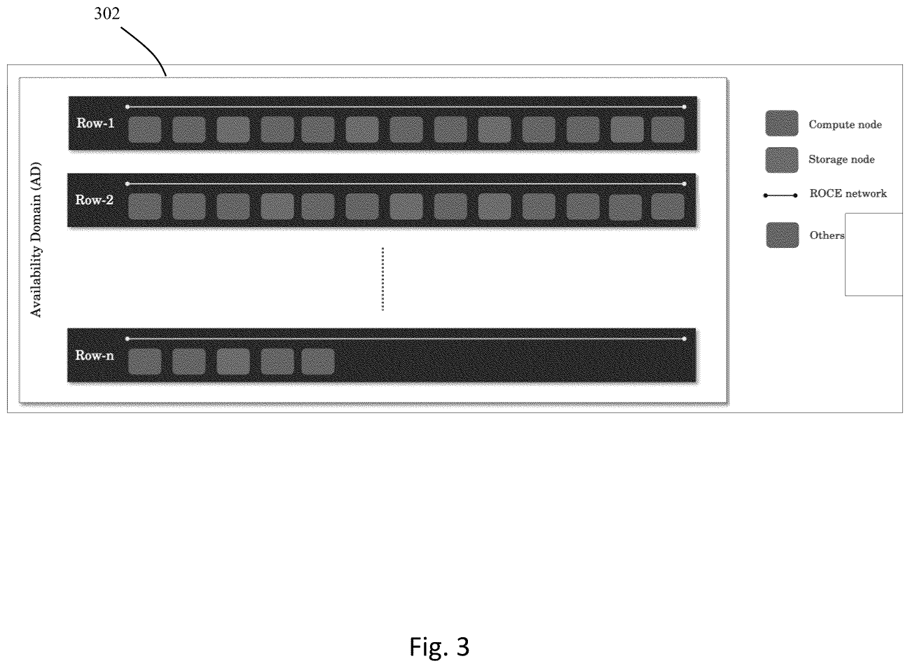

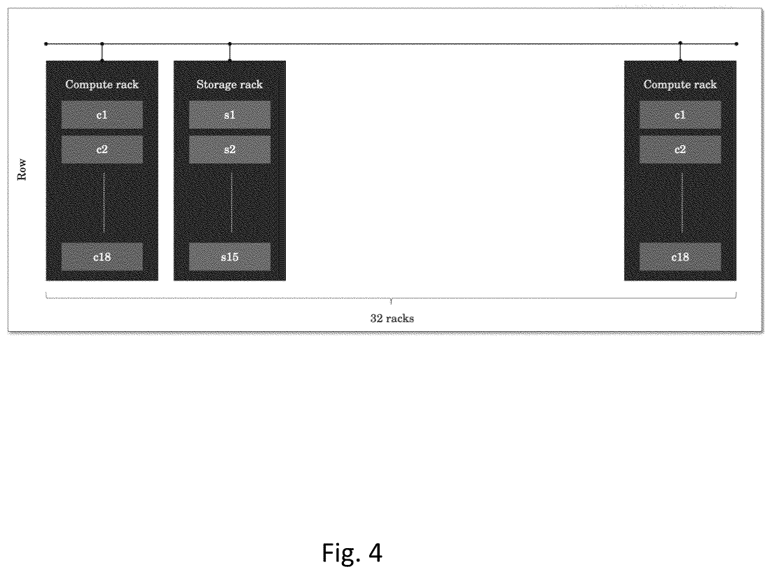

FIGS. 3 and 4 provide an illustration of an example environment in which some embodiments of the invention may be applied. As shown in FIG. 3, the environment may include multiple rows (fabrics) of racks within an Availability Domain (AD) 302. Within the AD the fabrics are also segregated into a plurality (e.g., 2 or 3) Fault Domains (FD). The rows may include both compute nodes and storage nodes, as we as perhaps other general or specialized nodes. The compute nodes host the VMs of multiple customer's clusters, and the storage nodes hold data from within the customer database.

As shown in FIG. 4, the racks within a row all share a common ROCE (RDMA over converged ethernet) network fabric. The network storage for the compute nodes comes from a storage service. Virtual Machines of a cluster should all come from the same fabric(row), so they can all share the storage. The fabrics(rows) may also host appliances belonging to other services and also multiple hardware version models could be present on the fabrics.

The placement of VMs on compute nodes of the fabric is one of the crucial design services in the system, there is a responsibility of the system for reserving the available resources including CPU, memory, and local storage. When delivering a common infrastructure hosting the VMs of multiple customers in a common fabric containing the storage nodes, there is a need for an optimized approach that factors the requested resource size, shape, amount, etc.

With some embodiments of the invention, the optimization of the placement mechanism aims to place the VMs of all customers on compute nodes in the fabrics such that the resources are utilized to full capacity without any significant wastage. This not only reduces the infrastructure investment that is needed, but also increases the potential ability to satisfy customer's requested VMs accommodation over the already possibly congested and/or ingested compute nodes. This approach not only optimizes from the resource consumption perspective, but also places the VMs optimally in terms of maintenance of the host node. This also allows for very crucial planned maintenance of the fabric and acts as one of the caveats for the possible downtime of customer's cluster.

When a request from the customer is received that includes a set of VMs in a cluster, a placement decision works on a state-to-state model where the system gets the previous fabric state as the base state to be worked upon. Once the system operates the requested operation over the base state of the fabric/infrastructure, an update is performed to record the new state back to the state store. This model adheres to basic client-server architecture and the current mechanism sits as the operation engine for the whole control flow.

Numerous cluster operations are supported using the current embodiment. By way of example, some or all of the following are supportable: (1) Cluster Create—Creating a set of new requested VMs; (2) Cluster Delete—Deleting all the VMs of the given cluster; (3) Cluster Update—Updating the Cluster can include 2 types of updates for the Cluster, including (a) Vertical Scaling—VM's size or specs changes and (b) Horizontal scaling—number of VMs of cluster changes; (4) VM Migrate—Migrate a given VM from one node to another similar configuration node; (5) VM Restart—Restarts a VM if running and starts if already stopped; (6) VM Start—Starts a VM if stopped else a no-ops; (7) VM Stop—Stops a VM if running else a no-ops; (8) Rollback—Rolls back the changes of a state with respect to the previous state. Each of the above operations accounts for a single state change in the state store and includes VM creation, deletion, and update in the underlying low-level operation for all operations.

This document will now provide a more detailed description of an approach to implement the algorithm used underneath these operations to implement the decision for the compute node to be selected. To optimize a decision under a given set of constraints defined by service principles, a constraint optimization problem is addressed to find a solution. According to some embodiments, the current approach heuristically optimizes the solution for each VM operation of the cluster.

By way of example, consider the VM Cluster create operation as a frequently used operation to create a VM cluster. The current approach defines a methodology to select the VM for the set of compute nodes and compare them for the optimization problem. There are numerous ways to take the placement decision and compute the most optimal placement mapping. One possible approach is to perform a “huffling Placement”. This type of placement includes the decision to take over all the mapping sets of a sample space compute node and VM. Another type of placement is the “Increment Placement”. This placement includes the decision for the best compute node among the sample set for each compute node in an incrementally online fashion and the decision for the linear degree sample set gets to be polynomial for each individual VM addition. According to some embodiments, one possible approach is to use a random order to minimize the expected value of the probability for deviation from the optimal order over the set of given VMs in multiple requests.

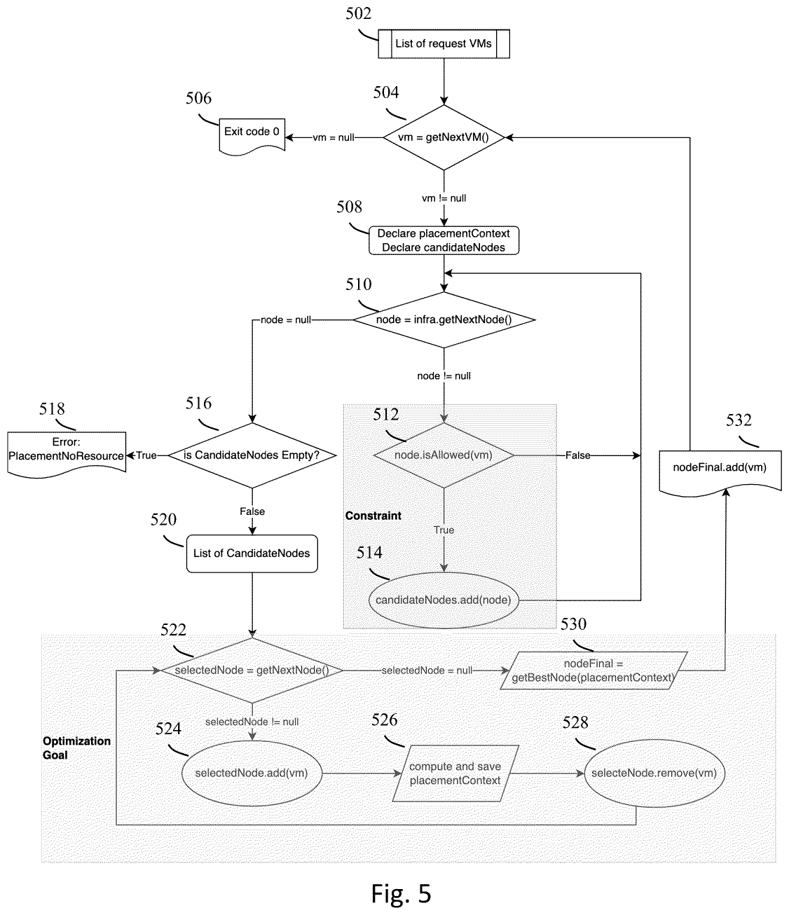

FIG. 5 shows a detailed flowchart of an approach to implement some embodiments of the invention. At 502, a list of requested VMs is received for placement. At 504, a determination is made of the next VM on the list for placement. If there are no further VMs on the list, then the processing ends at 506.

If there is a next VM for placement on the list, then at 508 a list of possible nodes is determined. It is noted that not all nodes qualify to be placed onto the list of nodes. For example, nodes that are already full would not be placed onto the list of candidate nodes.

At 510, a next node is taken from the list of nodes for processing. If there are not further nodes to process, then proceed to 516. If there are further nodes to process, then proceed to 512. A constraint-based procedure is then performed on the node. In particular, at 512, a determination is made whether the node is permitted to be considered as a candidate for a placement location for the VM. There are any number of constraints that may be imposed upon the ability to select a node as a candidate for a VM. For example, a high availability (HA) constraint may not permit two VMs from the same cluster to be placed onto the same node, and thus disqualify a given node from being a candidate node for this current algorithm. Other types of constraints may also be considered, such as constraints relating to policy, resource availability, etc. If the current node is not permitted to be a candidate node, then processing returns back to 510 to select another node from the list. If the current node is permitted to be a candidate node, then the node is added to a candidate node list at 514, and processing returns back to 510 to select another node from the list.

Once all nodes from the list have been processed, then the next action at 516 is to check whether the list of candidate nodes is now empty. If so, then the processing ends at 518.

If the list of candidate nodes is not empty, then the list 520 of candidate nodes is now considered from a goal-based perspective. At 522, a determination is made whether there is a next candidate node to select from the list of candidate nodes. If so, then at 524, the candidate node is saved to a context that will also store additional information to compute for the node.

In particular, at 526, computation is performed for the analysis measure for the node relative to the VM request. This is the computation of necessary metrics for each VM over each set of allowed nodes so that the optimal decision can be taken as a part of the optimization step. At 528, this computation result is saved in the context for the current candidate node.

The processing returns back to 522 to select another candidate node from the list for processing. One all nodes have been processed from the list, then at 530, a determination is made of the best candidate node from the list of candidate nodes, which is saved at 532. This step sorts the computed stats over the candidate nodes, and returns the compute-node corresponding to the most optimal objective function value.

Processing then returns back to 504 to select a next VM for processing. If there are no further VMs to process, then the processing ends at 506.

With regards to a statistics (Stats) computation to essentially score each node, a central goal is to optimize the VM distribution across the row (or fabric), which increases the chance to more efficiently pack the VMs of the cluster. This goal aims to compute the ratio of resources used over the total availability for each compute node as the resource density. This resource density for all the possible candidate nodes is used further to compute the standard deviation as a value for the objective function. As the value of this deviation is a quantifiable measure of the spread of VMs of all clusters over the fabric, higher the value for this implies a non-uniform spread and hence a less balanced distribution of the VMs.

Therefore, each VM being considered for the addition to the fabric computes this metric of resource density deviation and selects the node which minimally increases this metric. This optimization strategy aims to balance out the average spread density of resources at every VM addition to the fabric, and hence optimizes the goal.

This objective function can be represented as the below equation to be defined over the set of candidate nodes N:

$$argmin_{n\in N}\{\sum_{i\in res} w_{i}\sigma(\rho_{i}, n)+\sum_{i\in opt\_res} w_{i}\sigma(\rho_{i}, n)\}$$

In this equation, sigma represents a statistical value of deviation, w represents a weighting value, n represents a given node, N represents a total number of nodes, and rho represents a standard deviation across the nodes.

For a goal of VM-max optimization, a goal is to pack the VMs on each compute node to optimally utilize the resources and prevent possible wastage due to unforeseen technical limitations. As the VMs of different customers can be placed in a common infrastructure, the system should be able to maintain the isolation and resource quota required by each customer's VM hosted by the common hypervisor. As a single hypervisor is constrained to the available resources, its design complexities pose as the technical limitation for the maximum number of VM that could be provisioned on a single compute node, which is referred to herein as a configurable metric “VM-max” in this disclosure. Due to this being a constant for all the compute nodes of the fabric, there is a possibility of multiple small-size VMs being placed on the same compute node and hence causing a significant resource wastage of the available resource.

Therefore, some embodiments compute the metric of average resource usage by each VM of the compute node as a ratio of resource usage to the total number of VMs on compute node and compare it on a linearly interpolated scale to get a normalized value of the metric. This approach further defines “VM-optimum-density-deviation” as a metric that aims to quantify the deviation of the current density of resources allocated on average to each VM to the optimal density. The “optimal density” is defined similarly as an average of total available resources of the compute node to the total configured VM-max number of VM and hence marked as a 50% VM-optimum-density-deviation.

This metric can be calculated on a spectrum extending from extremes being mapped to the value of VM-optimum-density-deviation from 0 to 100 with 0 being the ideal case of 1 VM using the total available resource of the compute node, 100 being the worst case of small-sized VM occupying almost no resource of the compute node and thereby causing a significant resource wastage.

Some embodiments equate VM-optimum-density-deviation metrics using the below equation for the two cases across the optimal marking as:
1. For average resource density by each VM of compute node (say currentAverage)>=optimal density (say resourceAverage):
   resOptimumDensityDev=50−50*(currentAverage−resourceAverage)/(totalNodeResource−resourceAverage)
2. For average resource density by each VM of compute node<optimal density:
   resOptimumDensityDev=50+50*(resourceAverage−currentAverage)/(resourceAverage)

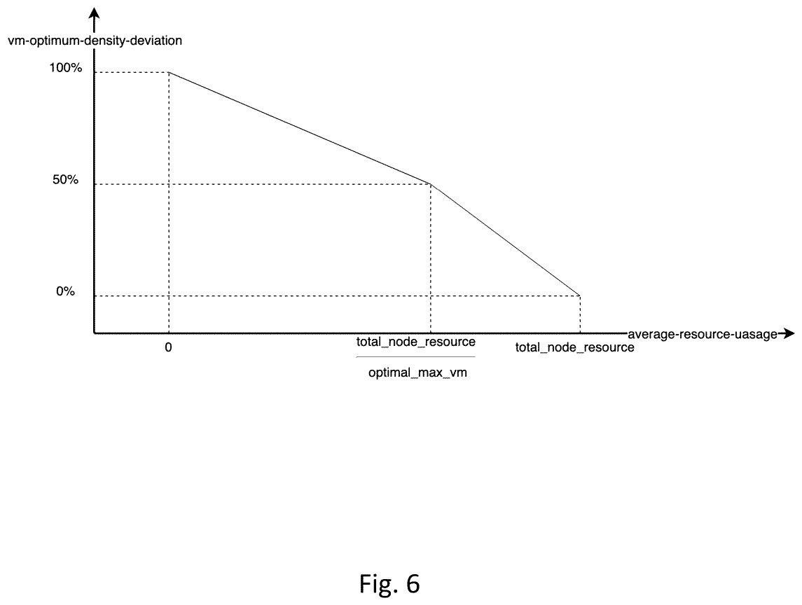

One can also plot the above-represented equation(s) as shown in FIG. 6. This figure represents the VM-optimum-density-deviation on the Y-axis, and the average resource usage along the X-axis.

Once the processing computes this metric for each compute node, the system can then compute the objective function similar to the previous use case by plugging in the standard deviation of these computed metrics as a weighted average. A weight can be defined to be given to each metric corresponding to each resource to be accounted for by the VM-max goal and select the node which minimally increases the objective function. A minimal increase in the objective function for each VM addition indicates a clear incremental optimization strategy to add the VM to compute node which gets packed optimally to reduce resource wastage.

One approach that can be taken to determine VM optimum density deviation is based upon the following calcualtions, which is based on a given VM-Max and set of resources say ‘n’ CPUs in a compute node. Here, (a) cpu_optimum_distribution_{[node]}=cpu_{[node]}/vm-max; (b) cpu_current_distribution_{[node]}=vm_cpus_{[node]}/vm-cnt_{[node]; (c)}res_avg=cpu_optimum_distribution; (d) cur_avg=cpu_current_distribution. The following is determined:
If cpu_current_distribution_{[node]}>cpu_optimum_distribution_{[node]}:
   ideal_avg=res_max #for 1 vm
   ideal_scale=ideal_avg−res_avg
   cur_delta=cur_avg−res_avg
   cpu_optimum_density_deviation=50−50*(cur_delta/ideal_scale)
else
   ideal_scale=res_avg
   cur_delta=res_avg−cur_avg
   cpu_optimum_density_deviation=50+50*(cur_delta/ideal_scale)

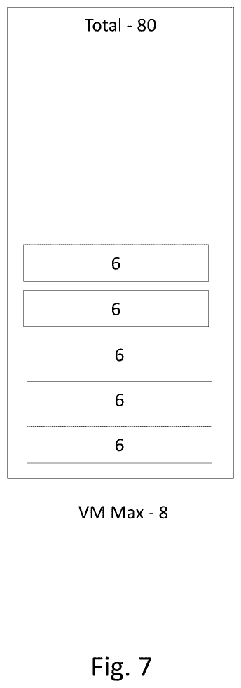

FIGS. 7-10 provide several examples of the determination of VM optimum density deviation.

In the example of FIG. 7, consider a scenario having 80 CPUs and 8 VM max. If 5 VMs are placed with 6 CPUs, then given VM-Max and set of resources say ‘n’ CPUs in a compute node, consider the following:
cpu_optimum_distribution_{[node]}=80/8=10
cpu_current_distribution_{[node]}=30/5=6
If cpu_current_distribution_{[node]}>cpu_optimum_distribution_{[node]}:
. . .
Else
ideal_scale=10
cur_delta=10−6=4
cpu_optimum_density_deviation=50+50*(cur_delta/ideal_scale)=50+50*(4/10)=70

This example of FIG. 7 therefore tends towards the worst case.

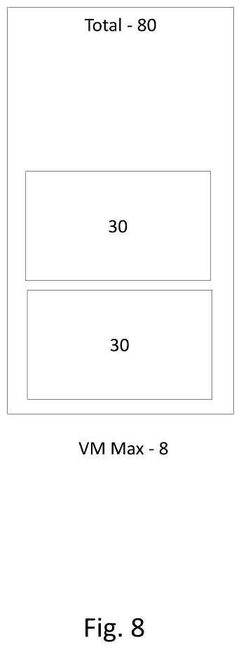

In the example of FIG. 8, consider a scenario having 80 CPUs and 8 VM max. If 2 VMs are placed with 30 CPUs, and given VM-Max and set of resources say ‘n’ CPUs in a compute node:
cpu_optimum_distribution_{[node]}=80/8=10
cpu_current_distribution_{[node]}=60/2=30
If cpu_current_distribution_{[node]}>cpu_optimum_distribution_{[node]}:
ideal_avg=80 # for 1 vm
ideal_scale=80−10=70
cur_delta=cur_avg−res_avg=30−10=20
cpu_optimum_density_deviation=50−50*(20/70)=35.42
Else
. . . .

This example of FIG. 8 therefore tends towards the better case.

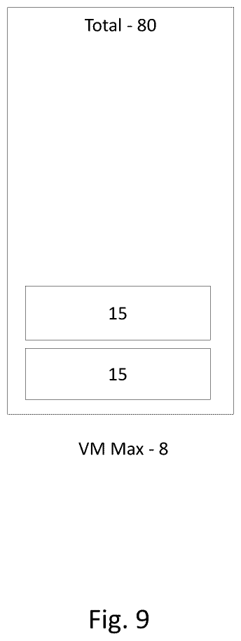

In the example of FIG. 9, consider a scenario having 80 CPUs and 8 VM max. If 2 VMs are placed with 15 CPUs, and given VM-Max and set of resources say ‘n’ CPUs in a compute node:
cpu_optimum_distribution_{[node]}=80/8=10
cpu_current_distribution_{[node]}=30/2=15
If cpu_current_distribution_{[node]}>cpu_optimum_distribution_{[node]}:
ideal_avg=80 # for 1 vm
ideal_scale=80−10=70
cur_delta=cur_avg−res_avg=15−10=5
cpu_optimum_density_deviation=50−50*(5/70)=46.42
Else
. . . .

This example of FIG. 9 therefore tends towards a good case.

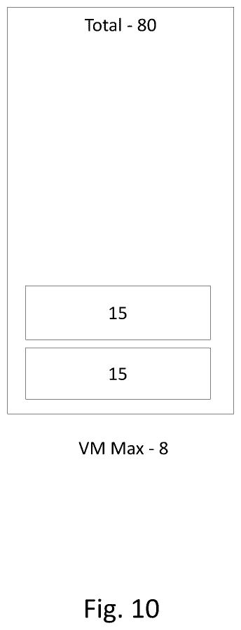

In the example of FIG. 10, consider a scenario having 80 CPUs and 8 VM max. If 4 VMs are placed with 10 CPUs each, and given VM-Max and set of resources say ‘n’ CPUs in a compute node:
cpu_optimum_distribution_{[node]}=80/8=10
cpu_current_distribution_{[node]}=40/4=10
If cpu_current_distribution_{[node]}>cpu_optimum_distribution_{[node]}:
. . .
Else
ideal_scale=cpu_optimum_distribution=10
cur_delta=cpu_optimum_distribution−cpu_current_distribution=10−10=0
cpu_optimum_density_deviation=50+50*(0/10)=50

This example of FIG. 10 therefore provides an optimum density.

Therefore, what has been described is an improved approach to implement database VM placement. The present approach can be used to implement an efficient distribution of VMs to maintain high availability and performance alongside efficiently reserving and utilizing the common backend resources.

### System Architecture Overview

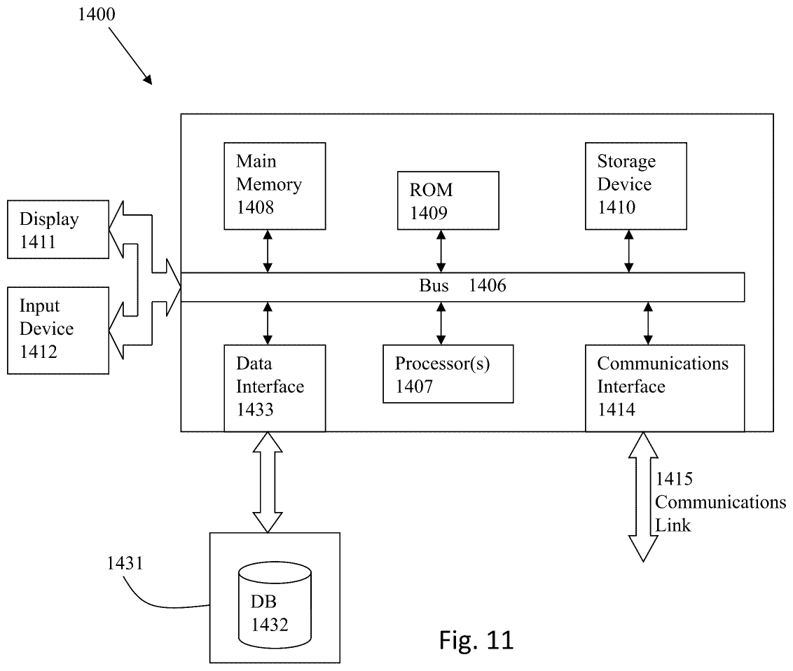

FIG. 11 is a block diagram of an illustrative computing system 1400 suitable for implementing an embodiment of the present disclosure. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), data interface 1433, and cursor control.

According to some embodiments of the disclosure, computer system 1400 performs specific operations by processor 1407 executing one or more sequences of one or more instructions contained in system memory 1408. Such instructions may be read into system memory 1408 from another non-transitory computer readable/usable medium, such as static storage device 1409 or disk drive 1410. In alternative embodiments, hard-wired circuitry may be used in place of or in combination with software instructions to implement the disclosure. Thus, embodiments of the disclosure are not limited to any specific combination of hardware circuitry and/or software. In some embodiments, the term “logic” shall mean any combination of software or hardware that is used to implement all or part of the disclosure.

The term non-transitory “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of non-transitory computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the disclosure, execution of the sequences of instructions to practice the disclosure is performed by a single computer system 1400. According to other embodiments of the disclosure, two or more computer systems 1400 coupled by communication link 1410 (e.g., LAN, PTSN, or wireless network) may perform the sequence of instructions required to practice the disclosure in coordination with one another.

Computer system 1400 may transmit and receive messages, data, and instructions, including program, e.g., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400 via data interface 1433.

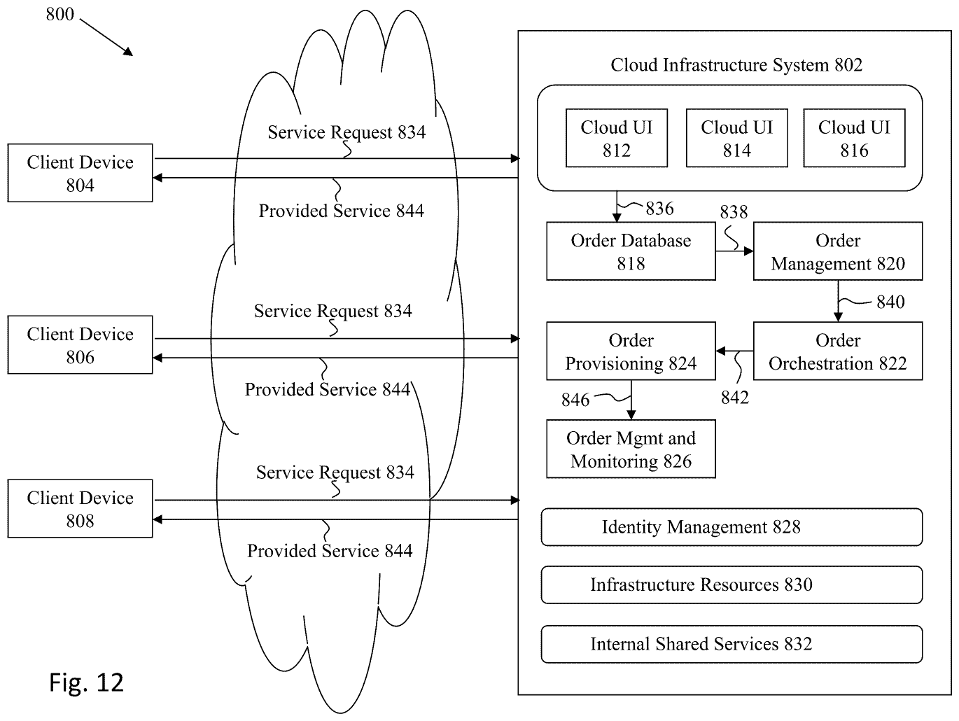

FIG. 12 is a simplified block diagram of one or more components of a system environment 1500 by which more efficient access to ordered sequences in a clustered database environment is provided, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the disclosure. In some other embodiments, cloud infrastructure system 1502 may have more or fewer components than shown in the figure, may combine two or more components, or may have a different configuration or arrangement of components. Client computing devices 1504, 1506, and 1508 may be devices similar to those described. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between client computing devices 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloud services via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that allow organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that allow organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1530 may allow a first set of users in a first time zone to utilize resources of the cloud infrastructure system for a specified number of hours and then allow the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client computing devices 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1502 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 allows the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 allows the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client computing devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

What is claimed is:

1. A method, comprising:
receiving a request to place a database virtual machine (VM) on a node in a cloud database system;
identifying candidate nodes in the cloud database system to place the database VM;
calculating a quantifiable metric with VM density deviation for the candidate nodes; and
using the quantifiable metric that was calculated to select a candidate node for placement of the database VM.

2. The method of claim 1, wherein a constraint-based approach is taken to identify the candidate nodes, where one or more constraints are applied to prevent selection of a given node from being a candidate node.

3. The method of claim 2, wherein a high availability (HA) constraint prevents selection of the given node from being the candidate node if this would cause two VMs from a same cluster to be placed onto a same node.

4. The method of claim 1, wherein a goal-based approach is taken to determine the quantifiable metric for the database VM.

5. The method of claim 4, wherein the goal-based approach optimizes for VM distribution across a set of nodes by computing a ratio of resources used over a total availability for each compute node as a resource density.

6. The method of claim 1, wherein scoring is determined for each of the candidate nodes, and a subsequent sorting is applied to select one of the candidate nodes for placement.

7. The method of claim 1, wherein a weighting is applied to each metric corresponding to each resource to be accounted for by a VM-maximum goal.

8. A computer program product embodied on a computer readable medium, the computer readable medium having stored thereon a sequence of instructions which, when executed by a processor, executes:
receiving a request to place a database virtual machine (VM) on a node in a cloud database system;
identifying candidate nodes in the cloud database system to place the database VM;
calculating a quantifiable metric with VM density deviation for the candidate nodes; and
using the quantifiable metric that was calculated to select a candidate node for placement of the database VM.

9. The computer program product of claim 8, wherein a constraint-based approach is taken to identify the candidate nodes, where one or more constraints are applied to prevent selection of a given node from being a candidate node.

10. The computer program product of claim 9, wherein a high availability (HA) constraint prevents selection of the given node from being the candidate node if this would cause two VMs from a same cluster to be placed onto a same node.

11. The computer program product of claim 8, wherein a goal-based approach is taken to determine the quantifiable metric for the database VM.

12. The computer program product of claim 11, wherein the goal-based approach optimizes for VM distribution across a set of nodes by computing a ratio of resources used over a total availability for each compute node as a resource density.

13. The computer program product of claim 8, wherein scoring is determined for each of the candidate nodes, and a subsequent sorting is applied to select one of the candidate nodes for placement.

14. The computer program product of claim 8, wherein a weighting is applied to each metric corresponding to each resource to be accounted for by a VM-maximum goal.

15. A system, comprising:
a storage medium having stored thereon a sequence of instructions; and
one or more processors that execute the sequence of instructions to cause the one or more processors to perform a set of acts, the set of acts comprising,
receiving a request to place a database virtual machine (VM) on a node in a cloud database system;
identifying candidate nodes in the cloud database system to place the database VM;
calculating a quantifiable metric with VM density deviation for the candidate nodes; and
using the quantifiable metric that was calculated to select a candidate node for placement of the database VM.

16. The system of claim 15, wherein a constraint-based approach is taken to identify the candidate nodes, where one or more constraints are applied to prevent selection of a given node from being a candidate node.

17. The system of claim 16, wherein a high availability (HA) constraint prevents selection of the given node from being the candidate node if this would cause two VMs from a same cluster to be placed onto a same node.

18. The system of claim 15, wherein a goal-based approach is taken to determine the quantifiable metric for the database VM.

19. The system of claim 18, wherein the goal-based approach optimizes for VM distribution across a set of nodes by computing a ratio of resources used over a total availability for each compute node as a resource density.

20. The system of claim 15, wherein scoring is determined for each of the candidate nodes, and a subsequent sorting is applied to select one of the candidate nodes for placement.

21. The system of claim 15, wherein a weighting is applied to each metric corresponding to each resource to be accounted for by a VM-maximum goal.
